(19) United States
(12) Patent Application Publication
(10) Pub. No.: US 2010/0119431 A1
(43) Pub. Date: May 13, 2010

(54) Strong Glass-Ceramic

(75) Inventors: Robert Ibsen, Santa Maria, CA (US); Xiaohui Chen, Whitechapel (GB); Michael J. Cattell, Whitechapel (GB); Jacques V. Riddell, Santa Maria, CA (US); Thomas C. Chadwick, Nipomo, CA (US)

Correspondence Address: SULLIVAN & WORCESTER LLP, 1666 K Street NW, Washington, DC, 20006, US

(73) Assignee: Den-Mat Holdings LLC, Santa Maria, CA (US)

(21) Appl. No.: 12/266,728

(22) Filed: Nov. 7, 2008

(51) Int. Cl. C01B 33/26

(52) U.S. Cl. 423/327.1

(57) ABSTRACT

The present invention relates generally dental ceramics. In particular, invention relates to a high strength, high reliability, dental glass-ceramic that contains uniform, ellipsoidal reinforcing leucite crystals.

This application claims the priority of U.S. Provisional Application No. 60/012,235 filed on Dec. 7, 2007, the disclosure of which is expressly incorporated by reference herein.

### FIELD OF THE INVENTION

The present invention relates generally dental ceramics. In particular, invention relates to a high strength, high reliability, dental glass-ceramic that contains uniform, ellipsoidal reinforcing leucite crystals.

### BACKGROUND OF THE INVENTION

The use of porcelain facings or veneers (also called porcelain laminates) to cover unsightly teeth and thereby improve their appearance was pioneered by Dr. Charles Pincus in 1928. Dr. Pincus fabricated his porcelain veneers by firing packed dental porcelain powder on platinum foil.

Because of the limited range of adhesives available at the time, veneers were cemented in place only temporarily. Because of their expense and the limitations imposed by the available adhesives, porcelain veneers were used primarily by movie stars during performances before the camera (for a detailed account of the early history of porcelain veneers see: J. Cosmetic Dentistry, 1 (3), 6-8 (1985)).

During the 1970's great improvements were made in the area of dental adhesives, and the use of porcelain veneers became popular among the general public. Because of the limitations in the strengths of existing porcelain, the technique of building a metal substructure and firing porcelain to the outside was also developed. Although this technique was successful and useful, it had its limitations. Paramount among the difficulties associated with porcelain-metal restorations was the need to match the coefficient of thermal expansion of the porcelain and the underlying metal and the need to opacify heavily the porcelain, so that the metal substructure would remain well hidden. The use of porcelain-fused-to-metal construction also made it possible to fabricate more complicated structures, such as porcelain jacket crowns and bridges, but the previously mentioned problems and the difficulty of bonding metal reliably to tooth structure made all-porcelain restorations a desirable goal.

In order to avoid the need for a metal substructure, much effort has been directed to strengthening dental porcelain. Attempts to strengthen dental porcelain have usually involved the inclusion of strengthening oxide particles in the base porcelain. Examples of strengthening oxides include zirconium oxide and aluminum oxide. The inclusion of strengthening oxides opacifies the porcelain and makes simultaneous control of opacity and strength impossible.

An ideal porcelain for the fabrication of all-porcelain veneers, crowns and bridges should possess high strength. Ideally, it should possess the strength of the metal-oxide-reinforced porcelains. It should be available in a range of opacities which ideally could run from very opaque to clear. The coefficient of thermal expansion of the porcelain should match the coefficients of thermal expansion of the bonding agents and underlying teeth. It should be available in a variety of shades, and the colorants should be incorporated in, rather than painted on, the porcelain.

Finally, the porcelain should be easy to fabricate by either the platinum foil or refractory model fabrication techniques. It should not show a pronounced tendency to separate during the initial firing, and any separation cracks that do form should heal easily rather than separate further. The maturing temperature should be below 1093° C. (2000° F.) to avoid any unnecessarily severe service for the vacuum furnaces. As a final point, the coefficient of thermal expansion should be less than 15×10⁻⁶° C.⁻¹ in order to avoid difficulty in matching refractory expansion to that of the porcelain.

Glass-ceramics containing leucite are known. A number of patents discuss the importance of controlling either the volume fraction of leucite in leucite-containing glass-ceramics or the size distribution of the leucite crystallites. Some patents discuss the need to control both, but none of them discuss methods for control of crystal size. EP00155564 and U.S. Pat. No. 4,604,366 discuss the importance of controlling the amount of leucite to control the thermal expansion of these materials, but they do not discuss desirable sizes of leucite crystals nor do they discuss control of crystal size. EP0272745, U.S. Pat. No. 4,798,536; U.S. Pat. No. 6,428,614; U.S. Pat. No. 6,761,760; and U.S. Patent applications US20030122270 and US20040121894 each mention that the leucite crystallites should be less than 35 microns and in some cases preferably less than 5 microns but they do not describe how these crystallite sizes are achieved, nor do they disclose glass-ceramics having the characteristics of those of the instant invention. U.S. Pat. No. 6,527,846 describes rod-like leucite crystals 0.3-1.5 microns wide and 7-20 microns in length but provides no indication of how to control the size of these rods but does not disclose glass-ceramics having the characteristics of those of the instant invention. U.S. Pat. No. 5,653,791; U.S. Pat. No. 5,944,884; and U.S. Pat. No. 6,660,073 all discuss leucite glass-ceramics containing leucite crystals less than 10 microns in size but do not indicate the method of size control nor do they disclose glass-ceramics having the characteristics of those of the instant invention. Patents JP23048770, U.S. Pat. No. 6,706,654 and US Patent application US20020198093 all describe a leucite glass-ceramic and lithium disilicate glass-ceramic blend in which the leucite is created from added leucite seed crystals. The role of leucite seed crystal size in determining the strength of the ceramic is discussed but there is no mention of the influence of glass particle size on ceramic properties. With the exception of U.S. Pat. No. 6,527,846, none of these patents discusses leucite crystal morphology.

U.S. Pat. No. 5,009,709 describes a dental porcelain that was useful for application in the stackable technique. The chemical composition of the porcelain of U.S. Pat. No. 5,009,709 is similar to the composition described in the present application, however, U.S. Pat. No. 5,009,709 does not disclose leucite and certainly does not disclose glass-ceramics having the characteristics of those of the instant invention. The present invention describes a dental glass-ceramic of superior strength having uniform, ellipsoidal reinforcing leucite crystals. World patent application WO 00/48956 (abandoned) describes a porcelain composition similar to that described in U.S. Pat. No. 5,009,709 that was useful for preparing dental restorations by the lost wax pressing technique. The application does not describe any means for controlling the size of the leucite crystals in the finished glass-ceramic, nor does it describe glass-ceramics having the characteristics of those of the instant invention.

### SUMMARY OF THE INVENTION

This invention relates to a high strength, high reliability (as described by the Weibull Modulus) dental glass-ceramic that contains very uniform, ellipsoidal reinforcing leucite crystals. The manufacturing process is distinguished by its ability to produce a leucite glass ceramic containing very uniform, small, reinforcing leucite crystals and the ability to control the average particle size of the leucite. The presence of numerous small, uniformly distributed leucite crystals seems to be key in producing a high strength glass-ceramic with a small (20-30%) volume percent of reinforcing leucite crystals. When the ceramic is processed into dental restorations by hot pressing, the uniformly small sized leucite crystals, the low crystal loading and the low viscosity glass matrix allow for easy processing of the glass ceramic over a broad pressing temperature range (1000-1100° C.). When the glass-ceramic is processed by CAD/CAM, the non-abrasive ceramic allows rapid processing and good milling tool longevity. The superior strength of this material is illustrated by a high flexural strength of 245 MPa (compare a flexural strength of 166 MPa for the widely used Empress Esthetic ETC2) and its high reliability as illustrated by a Weibull Modulus of 11.9 (compare 6.5 for Empress Esthetic).

One embodiment of the invention encompasses a high strength, high reliability, dental glass-ceramic that contains, 20-30%, by volume, uniform, ellipsoidal reinforcing leucite crystals.

### DETAILED DESCRIPTION OF THE INVENTION

For simplicity and illustrative purposes, the principles of the present invention are described by referring to various exemplary embodiments thereof. Although the preferred embodiments of the invention are particularly disclosed herein, one of ordinary skill in the art will readily recognize that the same principles are equally applicable to, and can be implemented in other systems, and that any such variation would be within such modifications that do not part from the scope of the present invention. Before explaining the disclosed embodiments of the present invention in detail, it is to be understood that the invention is not limited in its application to the details of any particular arrangement shown, since the invention is capable of other embodiments. The terminology used herein is for the purpose of description and not of limitation. Further, although certain methods are described with reference to certain steps that are presented herein in certain order, in many instances, these steps may be performed in any order as would be appreciated by one skilled in the art, and the methods are not limited to the particular arrangement of steps disclosed herein.

The present invention provides for a very strong, single frit, dental porcelain, glass-ceramic containing small, uniformly dispersed, single leucite crystals of ellipsoidal habit and very uniform particle size. When used as a powder, the glass-ceramic can be used with the platinum foil or refractory investment technique to produce dental restorations or it can be pressed and sintered into blocks or ingots and used in a variation of the lost wax casting technique or with CAD/CAM techniques to produce very strong, esthetic restorations.

In addition to possessing great strength the glass-ceramic is expected to cause only very low wear rates on opposing teeth. Moreover the improved strength and low wear rate are not obtained by sacrificing esthetics. The porcelain can be pigmented to produce a wide variety of the colors that are typical of natural teeth and it can be made clear or in any desired level of opacity.

The high strength, single-frit, leucite-containing, glass-ceramic containing leucite crystals of uniform and selectable size of the instant invention can be produced via a two-step fritting process. In the first step suitable components for the production of a glass of the correct chemical composition are mixed and fired to produce the glass. Although potassium feldspar is the major ingredient for the usual method of production, other raw materials can be used for the preparation of the glass. Other minerals, pure chemicals or sol-gel precursors would all function perfectly well for the production of the leucite-free glass with the only requirement being that the raw materials have the correct overall chemical composition to produce the glass. After the glass precursors have been fired to produce glass in the first firing, the glass is finely ground to a selected average particle size, blended with pigments and opacifiers and the mixture is refired to produce the glass-ceramic. The glass ceramic can then be ground to produce a powdered ceramic that can be used in processes such as the platinum foil or refractory die technique to directly produce porcelain restorations but the glass ceramic powder can also be shaped by die pressing and sintering to produce dental glass-ceramic ingots that can then be used for fabricating dental restorations such as veneers, inlays, onlays and crowns by hot pressing or CAD/CAM milling.

The production of high strength glass-ceramics containing uniformly dispersed single leucite crystals of reproducible, selectable and controllable size relies on several discoveries. First, it has been discovered that the control of leucite particle size in the finished glass-ceramic relies on the production of glass in the first firing stage that is leucite-free or nearly so. For purposes here, the term leucite-free means that there is no detectable leucite when powdered glass from the first firing is examined by powder x-ray diffraction. The detection limit of powder x-ray diffraction for leucite in a glass matrix is less than 1% (w/w). The control of the particle size distribution also relies on the discovery that there is a direct relationship between the particle size distribution of the powdered glass that is made from the glass produced in the first firing and the particle size distribution of leucite crystals in the finished glass-ceramic. Thus, it is possible to produce small leucite crystals in the finished glass-ceramic if the glass from the first firing is ground to a fine particle size and it is possible to produce larger leucite crystals if coarser glass powder is produced and used to make the glass-ceramic. The rapid production of small uniform leucite crystals also relies on the discovery that crystal nucleation and growth are quite rapid and can be done within the context of a firing that does not require a hold time at the nucleation temperature (600-700° C.). Although it is possible to exert additional control by halting at the nucleation temperature range it is not necessary to do so. This feature facilitates the rapidity and throughput of the process without compromising the ability to produce leucite crystals in a specific size range.

The invention provides:
1) a glass-ceramic with reinforcing crystals of leucite where the leucite crystal size can be easily controlled;
2) a glass-ceramic that exhibits high flexural strength;
3) a glass-ceramic, which contains small, uniform, ellipsoidal reinforcing leucite crystals, and which has low abrasivity toward the natural enamel of opposing teeth;
4) a glass-ceramic that, by virtue of uniformly sized, ellipsoidal crystals, low crystal loading and low viscosity residual glass has a very broad temperature range (1000-1100° C.) over which it can processed by hot pressing;
5) a low wear glass-ceramic which, when processed by the CAD/CAM technique, promotes machine tool longevity.

One method of making the glass-ceramics of the instant invention begins with selecting suitable starting materials to make the leucite-free glass. The most convenient starting material, and the ingredient that contributes the majority of material to the glass, is high potassium feldspar. Feldspar with a chemical composition consisting of silica, 64-68%, alumina, 17-19%, calcium oxide, 0.1-1.0%, potassium oxide, 9-11%, and sodium oxide, 2-4% is satisfactory. The commercial material, G-200 Feldspar, presently produced by The Feldspar Corporation, a subsidiary of ZEMEX Industrial Minerals, Inc., supplied with a mean particle size of approximately 12 microns is a satisfactory starting material. The second ingredient is a glass consisting of silica, 54-58%, alumina 5-9%, sodium oxide, 4-8%, potassium oxide, 18-22%, magnesium oxide, <4%, and calcium oxide, <4%. The third ingredient is another glass containing silica, 42-48%, alumina 0-2%, sodium oxide 18-22%, calcium oxide, <4%. The fourth ingredient is lithium carbonate. The particle size of the two glasses and the lithium carbonate should be similar to that of the feldspar.

The preparation of the leucite-free glass is accomplished by the usual methods of ceramic fabrication. The ingredients are weighed and then placed in a powder blender such as a twin cone or V cone blender and the ingredients are mixed to produce a uniform, homogenous powder. After the powders are a homogenous blend they are packed in refractory containers and fired to a temperature of at least 1300° C. and preferably 1350° C. and held at that temperature until a uniform, leucite-free melt is produced. This usually requires between 2 and 10 hours to accomplish. After the ingredients are thoroughly fused, the contents of the furnace are allowed to cool. The firing produces blocks of glass that are cleaned by sandblasting. After cleaning, the blocks are then crushed in a jaw crusher, screened to remove impurities from the crushing operation and then ground in a ball mill to produce glass powder with a mean particle size of approximately 10-25 microns.

In the next step the glass powder is wet ground to correct size in a Union Process attritor mill or other similar mill capable of reducing particle size into the 5 micron to 0.5 micron range. After the desired particle size is reached, the slurry of water and glass powder is discharged from the mill, the water is removed, the glass powder is dried by suitable means and the powder is then screened through a 325 mesh US series screen to remove agglomerates.

At this point, two alternatives can be used to produce the finished glass-ceramic. In the first alternative, the ground, powdered glass-ceramic precursor is mixed with opacifiers such as titanium oxide, zirconium oxide, zirconium silicate or tin oxide and single or multiple ceramic pigments that are necessary to give the glass-ceramic its proper final shade and opacity and the blended powders can then be pressed in a die to produce a powder compact. The powder compact can then be fired to 1120° C. to directly produce finished ingots that are suitable for use in hot pressing or CAD/CAM processes for the production of dental restorations.

Alternatively, the ground glass powders can be blended with opacifiers such as titanium oxide, zirconium oxide, zirconium silicate or tin oxide as well as individual ceramic pigments, packed in large refractory containers and the powder can be refired to 1120° C. The refractory containers are then removed from the furnace while hot and cooled rapidly in air. The resulting chunks of opacified, colored leucite glass-ceramic are then crushed and milled to produce a variety of glass-ceramic powders of different basic colors. These powders can then be blended to produce glass-ceramic powders of the correct final shade and opacity These blended powders can be used directly to produce dental restorations by the platinum foil or refractory die technique or the powder can be die pressed and sintered rapidly enough to preclude changes to the microstucture of the glass-ceramic so that ingots suitable for making dental restorations by the pressable technique or CAD/CAM technique can be produced. This latter process simplifies the problem of producing proper porcelain shades while the former process requires fewer steps to produce pressable, machineable ingots.

Note that the second firings associated with either process alternative may be modified to include a 0.10 to 4.0 hour hold at temperatures ranging from 600° C. to 700° C. These holds do allow some additional control over the nucleation process but they are not necessary for satisfactory results.

One method of making the present invention employs a two step process for the manufacture of a leucite containing glass-ceramic wherein the particle size distribution of leucite crystals in the product glass-ceramic is controlled to very narrow distributions over a wide range of average particle sizes. In the first step porcelain glass-ceramic precursors selected from naturally occurring feldspar, glasses of appropriate composition or metal oxides, carbonates, nitrates in any combination that will provide the correct elemental composition for the glass-ceramic are blended, if the components are already finely divided, or ground and blended if they are not, until the precursor mixture is homogenous and well mixed. The precursor mixture is then placed in a container of cordierite, mullite, silica or other suitable refractory and fired to a temperature above the liquidus for leucite, which in the compositional system of the present invention is approximately 1300° C. The mixture is held at this temperature for 2-10 hours, the holding period providing an opportunity to allow dissolution of the starting materials as well as any leucite that has crystallized during the heating process. After the holding period the mixture is allowed to cool slowly to room temperature. The leucite-free glass frit is usually obtained as solid, unfractured blocks, which are cleaned, crushed and reground to carefully controlled particle sizes that are selected to provide the desired leucite particle size in the final glass-ceramic. After grinding, the powders are dried (if a wet grinding process is employed), blended with pigments and opacifiers such as titanium dioxide, tin oxide, zirconium oxide, zirconium silicate or other equivalent materials and pressed into powder compacts. These powder compacts can then be fired from room temperature to 1120° C. at heating rates up to 10° C./min. A hold time of 0.10 to 4.0 hours in the temperature range including 600° C. to 700° C. may be optionally included so that additional control may be exerted over the nucleation of leucite crystals. When the upper temperature has been reached, the sintered compacts are removed from the furnace and allowed to air cool.

Alternatively, the blended powders may be processed in bulk. The powders can be placed in cordierite saggers that have been coated with a 3 mm layer of 50 micron tabular alumina powder. The cordierite saggers are fired to 1120° C. at average rates of 2.0-3.5° C. per minute and held at the high temperature for 45 minutes. After the holding period the containers holding the glass-ceramic are withdrawn immediately from the furnace and allowed to cool in air. When the glass-ceramic has cooled it is removed as chunks from the container, the chunks are cleaned and then crushed, ground and sieved. Different colored powdered glass-ceramics may be produced by this method and the different shades of powder can then be blended to produce the shades required for dental restoration manufacture. The blending of basic shades makes the process of shade matching much simpler than if the powders are produced to a specific shade by adding concentrated pigments directly to the ceramic.

### EXAMPLE 1

### Preparation of the Leucite-Free Glass

All raw ingredients were obtained and used as powders (−325 mesh, US Series screen) A batch (˜27 Kg) of frit was prepared by blending 22.226 Kg powdered potassium feldspar (composition of SiO₂, 66.3%, Al₂O₃, 18.50%, Na₂O, 3.04%, K₂O, 10.75%, CaO, 0.81% and MgO, 0.05%) with 3.922 Kg of a first glass powder (SiO₂, 55.4%, Al₂O₃, 7.19%, Na2O, 6.68%, K₂O, 20.2%, MgO, 1.92%, CaO, 8.32%, SrO, 0.05%, BaO, 0.22% and TiO₂, 0.02%), 0.534 Kg of a second glass powder (SiO₂, 46.6%, Al₂O₃, 0.615%, B₂O₃, 6.09%, MgO, 0.052%, CaO, 4.83%, SrO, 2.57%, BaO, 10.5%, Na₂O, 17.0%, K₂O, 0.22%, TiO₂, 9.46%, F, 3.65%) and 0.334 Kg of powdered lithium carbonate. After the raw materials were thoroughly blended the powder mixture was packed into square cordierite saggers (25 cm width and length and 8.5 cm deep)) that had previously been coated with a 3 mm layer of tabular alumina (50 micron average particle size). The saggers were then stacked into an electric furnace, fired rapidly to 1316° C. and held at that temperature for 7 hours. Power was shut off to the furnace after the hold period and the furnace was allowed to cool to room temperature over 2 days. After cooling, the glass was removed from the saggers as intact blocks, the blocks were cleaned of aluminum oxide by sandblasting and the blocks were then crushed to 1-5 cm chips. These chips were then ball milled to produce a powdered glass with an average particle size of 11.4 microns. The powdered frit was examined by Dr. Sampeth lyengar, Technology of Materials, Wildomar, Calif. (XRD analysis by the Rietveld technique) and Dr. Michael Cattell (XRD), Barts and the Royal London Hospital, London, England and both confirmed that there was no detectable leucite (i.e. leucite content was <1%) in the ground glass. The yield of ground frit was 22 Kg.

### EXAMPLE 2

### Preparation of Leucite-Free Glass, Ground for 4 Hours (2 Hours With 5 mm and 2 Hours With 2mm Media)

The frit of example 1 was used as the feedstock for the preparation of more finely ground glass powder. In most cases, grinding was carried out in a Union Process Attritor Mill (Union Process, 1925 Akron-Peninsula Road, Akron, Ohio 44313), Model 1-S. The mill was equipped with a 1 gallon water-jacketed grinding chamber and was driven by a 2 horsepower electric motor equipped with a variable speed drive. The particle size distributions of all ground ceramic powders were characterized with a Mastersizer/E particle analyzer (Malvern Instruments, UK).

Glass was ground for 4 hours by charging the attritor milling chamber with 12.3 Kg of 5 mm milling media, 1.00 Kg of glass powder prepared as described in Example 1 and 2.25 Kg of distilled water. The mill was run at 450 rpm for 120 minutes and the glass-water slurry was pumped from the chamber at the end of the milling period. The 5 mm media were removed and replaced with 13.3 Kg of 2 mm media, the glass-water slurry was replaced in the chamber and milling was continued under the same conditions for another 120 minutes. The slurry was then discharged from the mill, placed in large, rectangular Pyrex glass dishes, dried to constant weight and then sifted through a 100 mesh US series nylon screen.

### EXAMPLE 3

### Preparation of “480 Minute Grind” Glass

The glass of Example 1 was ground in an attritor with 5 mm media under conditions identical to those described in Example 2. After grinding, the glass-water slurry was placed in large, rectangular Pyrex glass dishes, dried to constant weight and then sifted through a 100 mesh US series nylon screen. The dried glass powder was then ground in a horizontal, small-media mill (Model DMQ-07, Union Process, Akron Ohio). Milling was done for 480 minutes at 3700 rpm with 1509 grams of 0.4 mm diameter zirconia media, 1520 g of the glass of Example 1 and 1520 g of distilled water. After grinding was complete the glass-water slurry was dried in Pyrex glass dishes to constant weight and then screened through a 100 mesh US series screen.

### EXAMPLE 4

### Preparation of Glass Ceramic Powder From Example 1 Glass

A 50 gram portion of glass powder from Example 1 was weighed and placed on refractory trays. Glass from Example 1 was heated at a rate of 10° C./min to 650° C., held at temperature for 1 hr and then heated to 1120° C., held at temperature for 1 hr and then removed and allowed to cool in air. Adhering refractory was removed from the glass-ceramic mass by sandblasting. The sample was then crushed and ground in a ball mill for 2 hours with a mixture of 19 mm and 26.4 mm diameter zirconia grinding balls. The glass-ceramic powder was then screened using a 125 μm sieve.

### EXAMPLE 5

### Preparation of Glass Ceramic Powder From Example 3 Glass

The glass of Example 3 was treated exactly as described in Example 4.

### EXAMPLE 6

### Preparation of Glass Ceramic Powder From Example 2 Glass

The glass of Example 2 was treated exactly as described in Example 4 except that the initial hold temperature was 610° C. and the final hold temperature was 1050° C.

Powdered glass-ceramics as well as blends of different colored glass-ceramics, prepared as described above, may be used to fabricate dental restorations by the stackable refractory or platinum foil techniques or the blended powder can be compressed in a die and the resulting powder compacts can be sintered to produce ingots for use in dental restoration fabrication by hot pressing or CAD/CAM machining

### Sintered Specimen Preparation

Portions (1.20 grams) of glass-ceramic powders from Examples 4 and 5 were mixed with modeling liquid (CH.B.24066, Vita, Germany), the powder slurries were transferred to a steel disc die (16 mm diameter×50 mm depth), vibrated for 1 minute, excess liquid was absorbed with tissue, and the residual moist powder was pressed at 3 bar for 1 minute. After removal from the die, the powder compacts were sintered in a dental porcelain furnace (Multimat MCII, Dentsply, Weybridge, UK) using the ingot firing cycle described in Table 1. Both sides of the fired disc specimens were flattened by lapping with P240 silicon carbide paper and finished by lapping in sequence with P320, P600, P800 and P1000 silicon carbide papers. The specimens were then ultrasonically cleaned for 10 minutes, blotted with tissue to dry and sintered using one stain firing and one glaze firing cycle (see Table 1).

TABLE 1
Firing Programs

| | Firing Program | | | |
|---|---|---|---|---|
| | | | | IPS Empress |
| | Ingot | | Glaze | stain-glaze |
| | Firing | Stain firing | firing | firing |
| Firing | 1040 | 780 | 860 | 770 |
| temperature (° C.) | | | | |
| Heating rate | 38 | 55 | 55 | 60 |
| (° C./min) | | | | |
| Standby | 538 | 550 | 550 | 403 |
| temperature (° C.) | | | | |
| Holding time | 2 | Nil | 1 | 1 |
| (min) | | | | |
| Drying time | 5 | 1 | 1 | 2 |
| (min) | | | | |
| Preheat (min) | 5 | 2 | 2 | 2 |
| Vacuum (hPa) | 55 | Nil | Nil | 55 |
| Vacuum release | 1025 | Nil | Nil | 769 |
| (° C.) | | | | |
| Cool time (min) | 3 | 3 | 3 | 1 |

### Pressable Ingot Fabrication

The glass-ceramic powder of example 6 was weighed (2.0 grams), and transferred to a steel die with a punch diameter 13.0 mm. The die punch was loaded with a hydraulic pressure of 0.5 bar and held for 30 seconds. After removal, the dry powder ingots were sintered in a dental porcelain furnace (Multimat MCII, Dentsply, Weybridge, UK) using the ingot firing cycle (see Table 1).

### Heat Pressing

Poly(methyl methacrylate) discs (14 mm diameter and 2 mm thickness) were sprued onto muffle bases with 3.0 mm diameter spruing wax and surrounded by rubber cylinders. Empress Esthetic speed investment material (200 g, Ivoclar-Vivadent, Schaan, Liechtenstein, Lot: GL3038) was mixed with 32 ml of IPS Empress Esthetic investment liquid (Ivoclar-Vivadent, Schaan, Liechtenstein, Lot: GL3034) and 22 ml distilled water and vacuum mixed for 90 seconds. The investment was then vibrated into the cylinder, and a muffle gauge was placed on the top of the cylinder to ensure a flat top surface of the refractory.

Commercial IPS Empress Esthetic ETC2 ingots (H22624, Ivoclar-Vivadent, Schaan, Liechtenstein) and alumina plungers were placed in a room temperature burnout furnace (5365, Kavo, Ewl, Germany) and heated to 850° C. at a rate of 3° C./minute. The refractories were given 45 minutes to set and then transferred to the preheated burnout furnace, heated at 850° C. for 45 minutes. Preheated Empress Esthetic ingots or room temperature Example 5 glass-ceramic ingots were placed into the refractory muffles followed by an alumina plunger, and heat extruded into the refractory using a 700° C. preheated Optimal automatic press furnace (Jeneric Pentron, Wallington, USA), using the programs described in Table 2. The pressure was delivered via a pneumatic rod integral in the press furnace during the heat pressing cycle.

TABLE 2
Heat Pressing Programs

| | IPS Empress Esthetic | Example 5 glass- |
|---|---|---|
| Heat Pressing Parameters | ETC2 | ceramic |
| Start temperature (° C.) | 700 | 700 |
| Pressing temperature high | 1075 | 1040 |
| (° C.) | | |
| Heating rate (° C./min) | 60 | 40 |
| Vacuum (%) | 101 | 101 |
| Holding time before pressing | 20 | 15 |
| (min) | | |
| Pressing time (min) | 15 | 10 |
| Pressing pressure (bar) | 5 | 5 |

After cooling, investment was removed from the sample discs by sandblasting 50 micron glass at 3 bar pressure and a diamond disc and bur were used to remove the sprue. All disc specimens were wet ground with P240, P320, P600; P800 and P1000 silicon carbide grinding paper in sequence on the compressive surface only, and the tensile surface was left as sandblasted. The specimens were then ultrasonically cleaned for 10 min and tissue dried. The Example 5 glass-ceramic specimens were fired in a dental furnace (Multimat MCII, Dentsply, Weybridge, UK) using one stain and one glaze firing (Table 1), and the IPS Empress specimens were fired using one stain and one glaze firing cycles (IPS Empress stain-glaze firing cycle in Table 1).

### Biaxial Flexural Strength Test

Four groups (n=30 per group) of disc specimens (IPS Empress, Example 4 glass-ceramic, Example 5 glass-ceramic and Example 6 glass-ceramic) were tested by centrally loading the disc specimen on a 10 mm diameter knife-edge support with a 4 mm diameter spherical ball indenter. A thin plastic sheet (0.03 mm) was positioned between the specimen surface and the indenter to distribute the load evenly. The load was delivered by Instron testing machine (5567/H1580, Instron, Buckinghamshire, UK) with a 30 KN load cell, at crosshead speed of 1 mm/min until failure. The biaxial flexural strength was calculated using the following equation (Timoshenko and Woinowsky-Krieger, 1959):

$${σ}_{max} = \frac{P}{{h}^{2}} \{ ( 1 + v ) [ 0.485 * ln ( \frac{a}{h} ) + 0.52 ] + 0.48 \}$$

Where σₘₐₓ was the maximum tensile stress, P was the measured load at fracture, h was the specimen thickness, a was the radius of the knife-edge support and the Poisson's ratio v of 0.25.

The strength data was analyzed using a one way ANOVA (Sigma Stat, version 2.03, SPSS Inc, Chicago, USA) and the results are listed in Table 3. The results were highly statistically significant (p=<0.001). The heat pressed Example 5 glass-ceramic had a significantly higher biaxial flexural strength value than the control Empress group and the Example 4 glass-ceramic group, when analyzed using Tukey's multiple comparison test (p<0.001). The biaxial flexural strength of the Example 6 glass-ceramic group is significantly different from the Example 4 glass-ceramic group and the IPS Empress group (p<0.001). There were no statistical differences between the heat pressed Example 5 glass-ceramic group and the Example 6 glass-ceramic group, or between the Example 4 glass-ceramic group and the IPS Empress group (p>0.05). The power of the test was 1.0 (p<0.05)

TABLE 3
Biaxial Flexural Strength Results

| | No of | Mean Strength | Standard Deviation |
|---|---|---|---|
| Test group | test | (MPa) | (MPa) |
| Example 4 | 30 | 153.2 | ±21.7 |
| Example 5 | 30 | 245.0 | ±24.3 |
| Example 6 | 30 | 221.7 | ±53.4 |
| IPS Empress | 30 | 165.5 | ±30.6 |

The Weibull analysis of the testing groups was performed by the Weibull program (Weibullsmith, Fulton Findings, USA) by comparing the overlapping of their double-sided confidence intervals at the 95% level (Table 4). The Weibull modulus of Example 5 glass-ceramic group was statistically higher than the control IPS Empress Group and the Example 6 glass-ceramic group, but not statistically different from the Example 3 glass-ceramic group. There was no difference between the Weibull modulus for the Example 3 glass-ceramic group and the control IPS Empress group, or for Example 6 glass-ceramic group and the IPS Empress group.

The characteristic strength of Example 5 glass-ceramic group and the Example 6 glass-ceramic group were significantly higher than the control IPS Empress group and the Example 4 glass-ceramic group, but there was no significant difference between characteristic strength values for the Example 5 glass-ceramic group and the Example 6 glass-ceramic group. The IPS Empress group and the Example 4 glass-ceramic group characteristic strengths were significantly different.

TABLE 4
Weibull Analysis Results

| | | | | IPS |
|---|---|---|---|---|
| | Example 4 | Example 5 | Example 6 | Empress |
| M value | 8.5 | 11.9 | 4.7 | 6.3 |
| C.i. for m | 6.9-10.4 | 9.3-15.1 | 3.7-5.9 | 5.0-7.9 |
| (95%) | | | | |
| σ_{0.01} (MPa) | 94.0 | 173.3 | 90.3 | 85.8 |
| σ_{0.1} (MPa) | 124.1 | 211.3 | 149.4 | 124.4 |
| σ₀ (MPa) | 162.0 | 255.5 | 242.1 | 177.5 |
| C.i. for σ₀ | 156.0-168.2 | 248.8-262.4 | 226.2-259.1 | 168.8-186.6 |
| (95%) | | | | |
| r² | 0.941 | 0.976 | 0.977 | 0.977 |

C.i.=confidence interval, m=Weibull modulus, σ_{0.01}=stress levels at 1% probability of failure, σ_{0.05}=stress levels at 5% probability of failure, σ_{0.10}=stress levels at 10% probability of failure, σ₀=the characteristic strength.

While the invention has been described with reference to certain exemplary embodiments thereof, those skilled in the art may make various modifications to the described embodiments of the invention without departing from the scope of the invention. The terms and descriptions used herein are set forth by way of illustration only and not meant as limitations. In particular, although the present invention has been described by way of examples, a variety of devices would practice the inventive concepts described herein. Although the invention has been described and disclosed in various terms and certain embodiments, the scope of the invention is not intended to be, nor should it be deemed to be, limited thereby and such other modifications or embodiments as may be suggested by the teachings herein are particularly reserved, especially as they fall within the breadth and scope of the claims here appended. Those skilled in the art will recognize that these and other variations are possible within the scope of the invention as defined in the following claims and their equivalents.

What is claimed is:

1. A glass-ceramic containing ellipsoidal leucite crystals of uniform size.

2. The glass-ceramic of claim 1, wherein the leucite crystals are less than one micron in size.

3. The glass-ceramic of claim 1, wherein the leucite crystals are less than one half of one micron in size.

4. The glass-ceramic of claim 1, wherein the glass ceramic has a high flexural strength.

5. The glass-ceramic of claim 4, wherein the flexural strength is greater than 166 MPa.

6. The glass-ceramic of claim 5, wherein the flexural strength is at least about 245 MPa.

7. The glass-ceramic of claim 1, wherein the glass-ceramic has a Weibull Modulus of greater than 6.5.

8. The glass-ceramic of claim 7, wherein the Weibull Modulus is at least about 11.9.

9. A glass-ceramic comprising small, uniform, ellipsoidal reinforcing leucite crystals, wherein said glass-ceramic has low abrasivity toward the natural enamel of opposing teeth.

10. The glass-ceramic of claim 9, wherein the leucite crystals are less than one micron in size.

11. The glass-ceramic of claim 9, wherein the leucite crystals are less than one half of one micron in size.

12. The glass-ceramic of claim 9, wherein the glass ceramic has a high flexural strength.

13. The glass-ceramic of claim 12, wherein the flexural strength is greater than 166 MPa.

14. The glass-ceramic of claim 13, wherein the flexural strength is at least about 245 MPa.

15. The glass-ceramic of claim 9, wherein the glass-ceramic has a Weibull Modulus of greater than 6.5.

16. The glass-ceramic of claim 15, wherein the Weibull Modulus is at least about 11.9.

17. A glass-ceramic comprising small, uniform, ellipsoidal reinforcing leucite crystals, wherein said glass-ceramic has low abrasivity toward the natural enamel of opposing teeth and wherein said leucite crystals are less than one micron in size.

18. The glass-ceramic of claim 17, wherein the leucite crystals are less than one half of once micron in size.

19. The glass ceramic of claim 17, wherein the glass-ceramic has a flexural strength that is at least about 245 MPa and a Weibull Modulus that is at least about 11.9.

20. The glass ceramic of claim 19, wherein the glass-ceramic comprises about 20-30% leucite crystals by volume.

21. The glass ceramic of claim 1, wherein the glass-ceramic is prepared by a method comprising:
preparing a leucite-free glass;
grinding the glass to the desired particle size in order to control the size of the leucite crystal in the finished ceramic; and
refiring to produce the glass-ceramic.
